(19) United States
(12) Patent Application Publication
(10) Pub. No.: US 2009/0085967 A1
(43) Pub. Date: Apr. 2, 2009

(54) CAPPING FIXTURE FOR DROPLET DISCHARGE HEAD

(75) Inventors: Eijiro FUJIMORI, Fujimi-machi (JP); Takayuki IMAI, Fujimi-machi (JP); Toru SHINOHARA, Suwa (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Tokyo (JP)

(21) Appl. No.: 12/234,200

(22) Filed: Sep. 19, 2008

(30) Foreign Application Priority Data
Oct. 1, 2007 (JP) 2007-257660

(51) Int. Cl. B41J 2/165

(52) U.S. Cl. 347/32

(57) ABSTRACT

A capping fixture is adapted to be coupled to a droplet discharge device including a droplet discharge head aligned on a unit plate of a carriage. The capping fixture includes a base panel, a head cap portion and an elastic member. The head cap portion is disposed on the base panel at a position corresponding to the droplet discharge head to hermetically seal the droplet discharge head when the capping fixture is coupled to the carriage of the droplet discharge device. The elastic member elastically couples the head cap portion with the base panel so that the head cap portion is movable within a prescribed distance in a direction substantially perpendicular to the base panel.

### CROSS-REFERENCE TO RELATED APPLICATIONS

This application claims priority to Japanese Patent Application No. 2007-257660 filed on Oct. 1, 2007. The entire disclosure of Japanese Patent Application No. 2007-257660 is hereby incorporated herein by reference.

### BACKGROUND

1. Technical Field

The present invention relates to a capping fixture for a droplet discharge head.

2. Related Art

An inkjet device, i.e., a droplet discharge device, for discharging a functional liquid in the form of droplets is commonly known as a device for forming a desired pattern on a substrate using a functional liquid. The droplet discharge device forms a pattern by arranging droplets of a functional liquid discharged from a droplet discharge head in arbitrary locations on a substrate while moving the substrate mounted on a stage and the droplet discharge head for discharging droplets of the functional liquid relative to each other in two dimensions.

A droplet discharge device has recently become known in which a plurality of droplet discharge heads is mounted on a single carriage, and a plurality of carriages is furthermore provided. Such a droplet discharge device is used for large-screen color filter manufacturing and the like, and the drawing speed thereof is enhanced by discharging droplets at the same time from a plurality of carriages.

In the droplet discharge head, the functional liquid is fed from a separately provided tank or the like, and the fed functional liquid is temporarily retained in an ink chamber (cavity) provided inside the droplet discharge head. The functional liquid retained in the ink chamber is discharged as droplets from numerous nozzle holes that are formed in a nozzle plate provided so as to face a stage.

When the droplet discharge head is in standby, the functional liquid retained in the ink chamber may dry out. When the functional liquid dries, not only do the viscosity increase and the discharge quantity change, but the functional liquid may also harden and cause nozzle hole blockage, flight deflection during discharge, and other problems.

A method for preventing drying of the functional liquid in the ink tank has therefore been proposed, in which a seal member referred to as a cap is automatically brought into contact with the nozzle plate of the droplet discharge head to prevent drying of the functional liquid (Japanese Laid-Open Patent Application No. 5-42676, for example). A proposal has also been made to connect a suction means to the cap and forcibly discharge the functional liquid of the ink tank (Japanese Laid-Open Patent Application No. 6-336018, for example).

### SUMMARY

However, when these methods are applied to the droplet discharge device described above, it is also necessary to provided caps for sealing the droplet discharge heads, raising and lowering means for automatically raising and lowering the caps, suction means for suctioning the functional liquid of the ink tank via the caps, and other components. The automatic capping device provided with these components has a large size, and the cost of the droplet discharge device is difficult to reduce. Unlike a droplet discharge device such as a home printer, the droplet discharge device described above is rarely stopped for long periods, and the opportunities for an automatic capping device to be used are extremely limited.

The present invention was developed in order to overcome the abovementioned problems, and an object of the present invention is to provide a capping fixture for a droplet discharge device that can easily be attached and detached by hand, and that suppresses drying of the functional liquid inside the droplet discharge head.

A capping fixture according to one aspect of the present invention is adapted to be coupled to a droplet discharge device including a droplet discharge head aligned on a unit plate of a carriage. The capping fixture includes a base panel, a head cap portion and an elastic member. The head cap portion is disposed on the base panel at a position corresponding to the droplet discharge head to hermetically seal the droplet discharge head when the capping fixture is coupled to the carriage of the droplet discharge device. The elastic member elastically couples the head cap portion with the base panel so that the head cap portion is movable within a prescribed distance in a direction substantially perpendicular to the base panel.

In the capping fixture for a droplet discharge head according to the present invention, even when there are deviations in the height positions of the droplet discharge heads arranged in the unit plate, the elastic member that elastically supports the head caps can absorb the height position deviations, and all of the droplet discharge heads can be reliably sealed. Consequently, drying of the functional liquid can be suppressed in all of the droplet discharge heads arranged in the unit plate.

The capping fixture may further include a connecting retention part configured and arranged to connect and retain the base panel to the carriage when the capping fixture is coupled to the carriage.

According to this capping fixture for a droplet discharge head, providing the connecting retention means for connecting and retaining the base panel in relation to the carriage enables the capping fixture to be manually attached to and detached from the carriage. Consequently, there is no need to provide a large-sized capping device provided with an automatic raising and lowering device for raising and lowering the capping fixture, for example, and the manufacturing cost of the droplet discharge device can be reduced.

The capping fixture may further include a positioning member configured and arranged to position the head cap portion with respect to the droplet discharge head when the capping fixture is coupled to the carriage.

According to this capping fixture for a droplet discharge head, providing a positioning member for positioning the head caps with respect to the corresponding droplet discharge heads enables the head caps to be reliably brought into close contact with all of the droplet discharge heads arranged in the unit plate. Consequently, drying can be reliably suppressed in the droplet discharge heads.

The capping fixture may further include a height adjusting member configured and arranged to adjust a gap between the unit plate of the carriage and the base panel when the capping fixture is coupled to the carriage, the height adjusting member having a contacting part that contacts the unit plate when the capping fixture is coupled to the carriage.

According to this capping fixture for a droplet discharge head, providing the height adjusting means for adjusting the gap between the unit plate and the base panel makes it possible to adjust the gap between the head caps and the base panel when the capping fixture is attached to the carriage. Specifically, the elastic force created by the elastic member in the separation direction can be adjusted. Consequently, the close contact of the head caps with the corresponding droplet discharge heads can be adjusted. As a result, the droplet discharge heads can be more reliably sealed.

The capping fixture may be arranged so that the contacting part includes a magnet.

According to this capping fixture for a droplet discharge head, the contacting part for making contact with the unit plate is provided with a magnet; e.g., the unit plate is formed by a magnetic material, whereby the capping fixture can be easily retained in close contact with the unit plate. Consequently, the capping fixture can easily be attached to the unit plate by using the connecting retention means to fix the capping fixture after the capping fixture is retained in close contact by the contacting part (magnet).

The capping fixture may further include a release lever configured and arranged to release the contacting part from the unit plate when the capping fixture is separated from the carriage.

According to this capping fixture for a droplet discharge head, the contacting part (magnet) can easily be released from the unit plate by providing a release lever for releasing the contacting part (magnet) from the unit plate. As a result, the capping fixture can easily be removed from the carriage.

The capping fixture may further include a holding member configured and arranged to hold a duct connection member connected to the carriage when the capping fixture is coupled to the carriage.

According to this capping fixture for a droplet discharge head, the duct connection member can be fixed to the fixing member and conveyed during conveyance or at other times, for example, by providing the fixing member for fixing the duct connection member connected to the droplet discharge heads. Consequently, since the duct connection member does not impede conveyance, the carriage can easily be conveyed.

### BRIEF DESCRIPTION OF THE DRAWINGS

Referring now to the attached drawings which form a part of this original disclosure:

FIG. 1 is a perspective view showing an overall structure of a droplet discharge device;

FIG. 2 is a side elevational view showing the relationship between the carriage plates and the carriage;

FIG. 3 is a perspective view showing the overall structure of the unit plate of the carriage on which the droplet discharge head is mounted as viewed from the nozzle plate side;

FIG. 4 includes a pair of diagrams (a) and (b), wherein FIG. 4(a) is a perspective view showing the droplet discharge head as viewed from the nozzle plate; and FIG. 4(b) is a simplified sectional view showing the droplet discharge head;

FIG. 5 is a perspective view showing the capping fixture attached to the carriage in the first embodiment;

FIG. 6 is a perspective view showing the capping fixture in the first embodiment;

FIG. 7 is a diagram showing the relationship between the head cap and the base panel;

FIG. 8 is a perspective view showing the capping fixture attached to the carriage in the second embodiment; and

FIG. 9 is a perspective view showing the capping fixture in the second embodiment.

### DETAILED DESCRIPTION OF EXEMPLARY EMBODIMENTS

### First Embodiment

An embodiment of the pattern formation device in which the present invention is implemented will be described below according to the drawings.

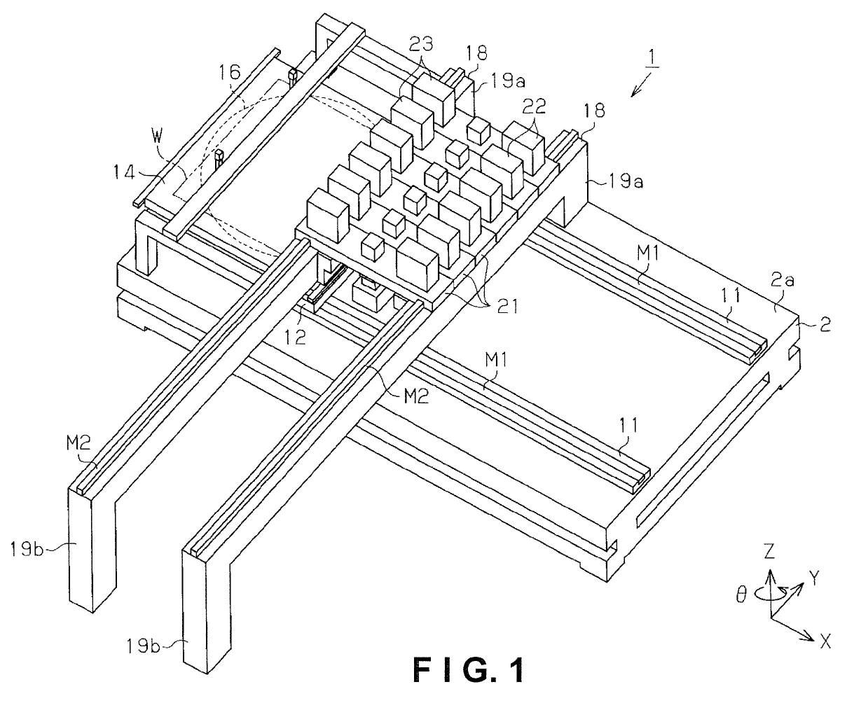

FIG. 1 shows the overall structure of the droplet discharge device 1 as the pattern formation device for forming red, green, and blue color filters on a glass substrate on which a black matrix is formed. In the droplet discharge device 1 as shown in FIG. 1, a base 2 that extends in the primary scanning direction (X-axis direction) is provided on a floor surface, a pair of X-axis guide rails 11 are laid on the upper surface 2a of the base in the primary scanning direction (X-axis direction), and an X-axis movement plate 12 is mounted on the pair of X-axis guide rails 11. The X-axis movement plate 12 is mounted so as to be able to move in the primary scanning direction along the X-axis guide rails 11. X-axis linear motors M1 are provided to the pair of X-axis guide rails 11, and the X-axis linear motors M1 move the X-axis movement plate 12 mounted on the pair of X-axis guide rails 11 back and forth in the X-axis direction via an air slider (not shown).

In FIG. 1, the primary scanning direction is the X-axis direction, the secondary scanning direction orthogonal to the primary scanning direction (X-axis direction) is the Y-axis direction, the direction (vertical direction) orthogonal to the X-axis direction and Y-axis direction is the Z-axis direction, and the direction of rotation about the Z-axis direction is the θ direction.

A substrate stage 14 is provided on the upper surface of the X-axis movement plate 12. The substrate stage 14 is a vacuum suction table, a color filter substrate (referred to as a CF substrate) W composed of a glass substrate is suction-fixed to the upper surface of the substrate stage, and the CF substrate W is conveyed. The substrate stage 14 is supported and fixed so as to be able to rotate in the θ direction with respect to the X-axis movement plate 12 by a stage rotation mechanism 16 indicated by a dashed line provided between the X-axis movement plate 12 and the substrate stage 14.

Consequently, the substrate stage 14 (CF substrate W) moves together with the X-axis movement plate 12 in the X-axis direction (primary scanning direction). The substrate stage 14 (CF substrate W) also rotates in the θ direction parallel to the plane (XY plane (horizontal plane)) of the X-axis movement plate 12.

A pair of Y-axis guide rails 18 are provided so as to straddle over the X-axis guide rails 11 in the Y-axis direction. Support columns 19a at one end of the pair of Y-axis guide rails 18 are provided upright on one side of the upper surface 2a of the base 2, and support columns 19b at the other end are provided upright on the floor at a distance from the base 2. The pair of Y-axis guide rails 18 are arranged parallel to each other across a prescribed interval in the X-axis direction. In the pair of Y-axis guide rails 18 extending parallel to each other in the Y-axis direction in the present embodiment, the position above the base 2 is the work area, and the position at a distance from the base 2 is the standby area.

A plurality (six in the present embodiment) of carriage plates 21 is arranged so as to bridge the space between the pair of Y-axis guide rails 18. The carriage plates 21 are mounted so as to be able to move in the secondary scanning direction (Y-axis direction) along the Y-axis guide rails 18. The pair of Y-axis guide rails 18 are provided with Y-axis linear motors M2, and the Y-axis linear motors M2 move each of the carriage plates 21 mounted on the pair of Y-axis guide rails 18 reciprocally in the Y-axis direction via an air slider (not shown). In other words, the carriage plates 21 move on the Y-axis guide rails 18 back and forth between the work area and the standby area.

It should be noted that when the droplet discharge device 1 is at rest, the carriage plates 21 are guided to the standby area and are made to stand by in the standby area until the next activation of the droplet discharge device 1.

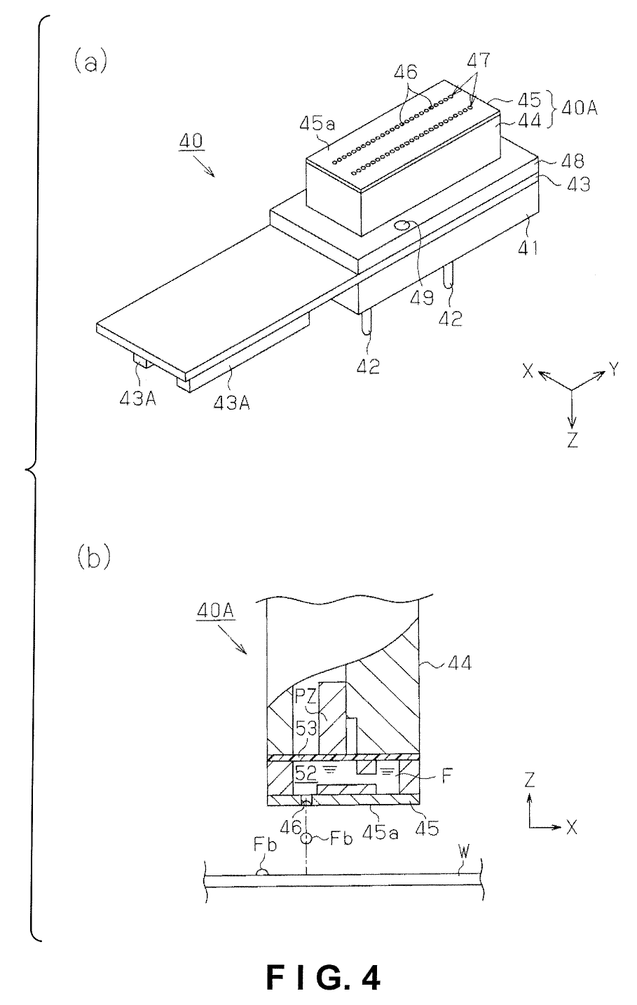

Functional-liquid feeding units 22 and head electrical installation units 23 are mounted on the upper surface of each carriage plate 21. The functional-liquid feeding units 22 are supply circuit devices for storing a prescribed quantity of the functional liquid F (see FIG. 4(b)) and feeding the functional liquid F to droplet discharge heads 40 (see FIGS. 4(a) and 4(b)). The head electrical installation units 23 are electrical circuit devices for feeding electric signals for driving the droplet discharge heads 40.

The functional liquid F referred to herein is red, green, and blue filter ink that is placed in the frames of the black matrix formed on the CF substrate W. The functional liquid F is arranged in the frames of the black matrix formed on the CF substrate W, and is then dried to form red, green, and blue filters.

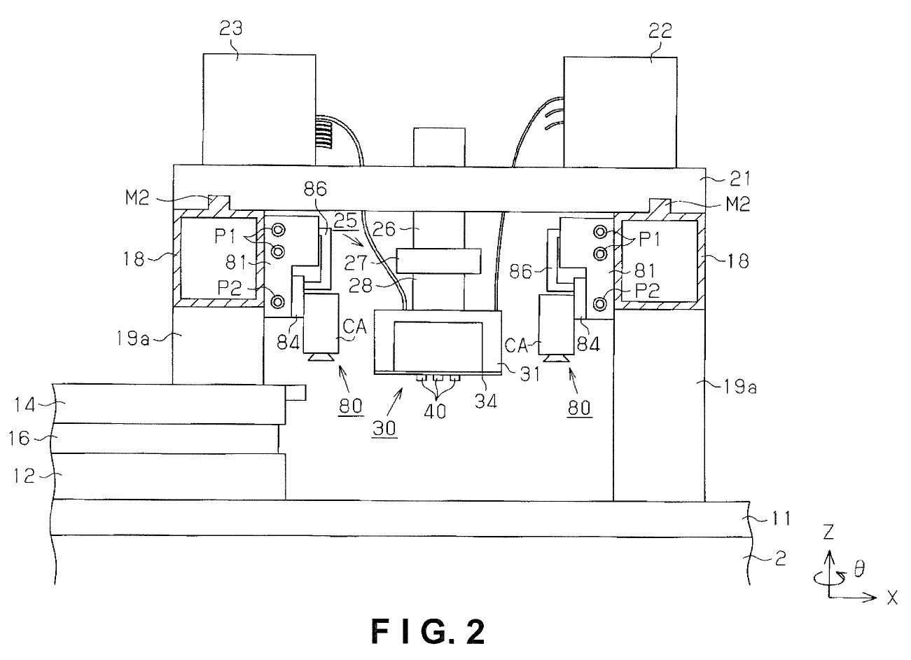

As shown in FIG. 2, a suspension mechanism 25 is provided in the center position of the lower surface of each carriage plate 21, and a carriage 30 is attached to the lower end part of the suspension mechanism 25.

The suspension mechanism 25 has a suspension base plate 26, a suspension rotation frame 27, and a suspension support frame 28. The suspension base plate 26 is connected and fixed in position at the center of the lower surface of the carriage plate 21, and the suspension rotation frame 27 is connected to the lower end part thereof. The suspension support frame 28 is connected to and supported by the lower end part of the suspension rotation frame 27 so as to be able to rotate in the θ direction. The suspension rotation frame 27 has a θ-axis rotation motor (not shown), and the θ-axis rotation motor rotates the suspension support frame 28 in the θ direction with respect to the suspension base plate 26 (carriage plate 21). The carriage 30 is supported by and fixed to the suspension support frame 28, and the carriage 30 hung from the suspension mechanism 25 is rotated in the θ direction.

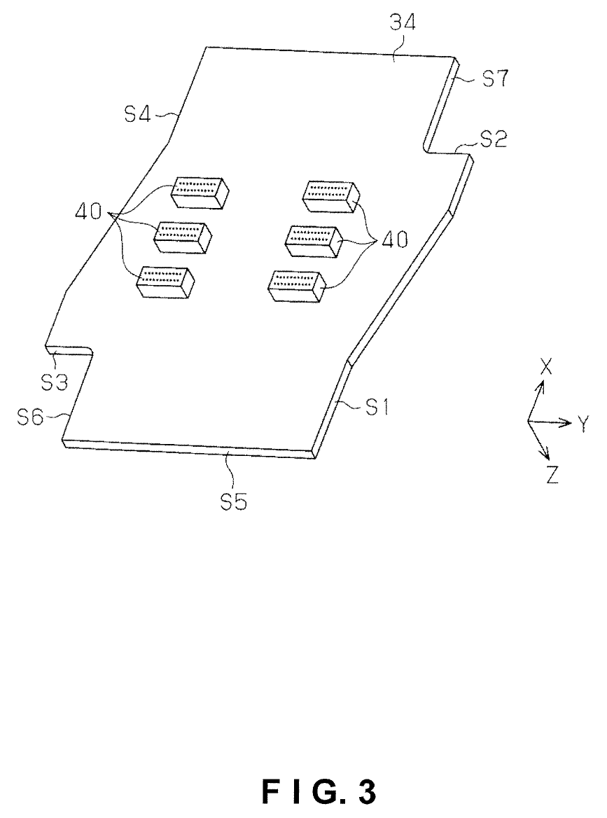

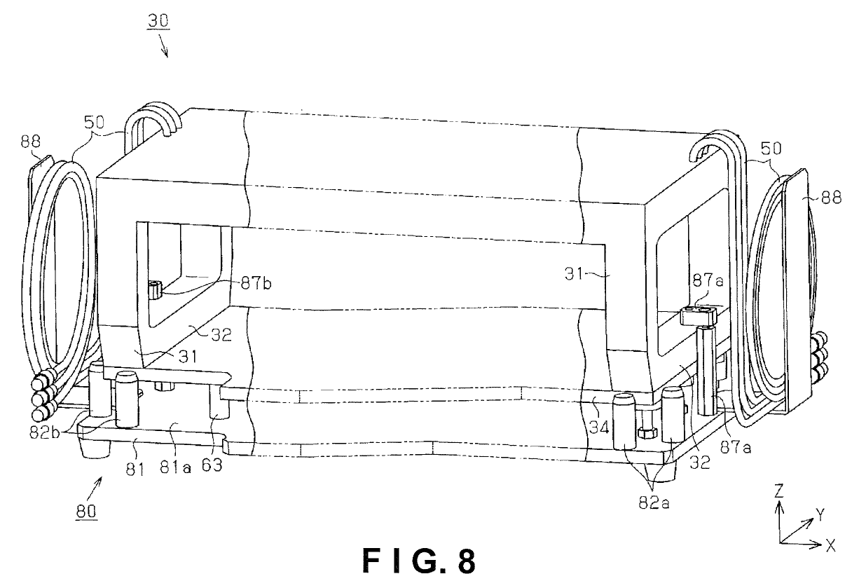

The carriage 30 has a substantially rectangular cuboid carriage frame 31. Open parts are provided on both sides of the carriage frame 31 in the X-axis direction and the Y-axis direction (the open parts in the X-axis direction are shown in FIG. 8), and the surrounding air can flow in and out with respect to the inside of the carriage frame 31. A unit plate 34 is fixed by a screw or the like (not shown) to the lower end part of the carriage frame 31 of the substantially rectangular cuboid carriage 30. Droplet discharge heads 40 are detachably attached to the unit plate 34 and fixed in precise positions. In the present embodiment, three droplet discharge heads 40 arranged along the X-axis direction are attached in two rows parallel to the Y-axis direction; i.e., a total of six droplet discharge heads 40 are attached, as shown in FIG. 3. Ducts, wiring, and the like are provided inside the carriage frame 31, but are omitted from the drawings in order to reduce complexity.

### Droplet Discharge Heads 40

The droplet discharge heads 40 attached to the unit plate 34 will next be described with reference to FIG. 4, FIG. 4(a) is an external perspective view showing a droplet discharge head as viewed from the substrate stage 14. The droplet discharge head 40 is provided with a liquid body introduction part 41 having two connecting pins 42; a head base plate 43 that continues to the side of the liquid body introduction part 41; a pump unit 44 that continues into the liquid body introduction part 41; and a nozzle plate 45 that continues into the pump unit 44.

A duct connecting member (see FIG. 2) 50 that is connected to the functional-liquid feeding units 22 is connected to the connecting pins 42 of the liquid body introduction part 41. A pair of head connectors 43A are mounted to the head base plate 43, and a flexible flat cable (not shown) connected to the head electrical installation units 23 is connected to the head base plate 43 via the head connectors 43A.

A rectangular head body 40A is formed by the pump unit 44 and the nozzle plate 45.

Two nozzle rows 47 composed of discharge nozzles 46 for discharging droplets Fb are formed in the nozzle formation face 45a of the nozzle plate 45. The two nozzle rows 47 are arranged parallel to each other, and each of the nozzle rows 47 is composed of 180 (shown schematically in the drawing) discharge nozzles 46 aligned at an equal pitch. Specifically, the two nozzle rows 47 are arranged symmetrically about the center line of the nozzle formation face 45a of the head body 40A.

FIG. 4(b) shows the inside of the pump unit 44 of the droplet discharge head 40, and above each of the discharge nozzles 46 is a cavity 52, an oscillation plate 53, and a piezoelectric element PZ. The cavities 52 are connected to a functional-liquid feeding unit 22 via the duct connecting member, and accommodate the functional liquid F (filter ink) from the same functional liquid feeding unit 22 and feed the filter ink to the discharge nozzles 46. The oscillation plates 53 vibrate the regions opposite the cavities 52 in the Z direction, thereby expanding and contracting the volume of the cavities 52, and a meniscus of each discharge nozzle 46 is thereby vibrated. When the piezoelectric elements PZ receive a signal having a prescribed drive waveform, the piezoelectric elements PZ contract and extend in the Z direction, thereby vibrating the regions of the oscillation plates 53 in the Z direction. When the oscillation plates 53 vibrate in the Z direction, a portion of the accommodated filter ink in the cavities 52 is discharged as a droplet Fb from a discharge nozzle 46.

A rectangular flange-shaped flange part 48 to receive the liquid body introduction part 41 is formed at the base of the pump unit 44; i.e., the base of the head body 40A. The flange part 48 prevents unseating, and also acts as a connecting part that is connected and fixed to the unit plate 34 by a head fixing screw (not shown). A pair of screw holes (female screws) 49 for small screws that fix the droplet discharge head 40 to the unit plate 34 are formed in the flange part 48. In other words, the head body 40A is inserted through a through-hole (not shown) formed in a prescribed position of the unit plate 34, and the droplet discharge head 40 is fixed to the unit plate 34 by the head fixing screw (not shown) that passes through the unit plate 34 and engages with a screw hole 49.

The X-axis, Y-axis, and Z-axis shown in FIGS. 2 through 4 are the same as the X-axis, Y-axis, and Z-axis shown in FIG. 1. Specifically, in the state in which the unit plate 34 is attached to the droplet discharge device 1, the nozzle rows 47 (see FIG. 4) formed in the droplet discharge head 40 extend in the Y-axis direction.

### Capping Fixture 60

Following is a description of the capping fixture 60 for preventing drying of the droplet discharge heads 40 of the carriages 30 during standby when the droplet discharge device 1 is at rest, and all of the carriages 30 (carriage plates 21) are in standby in the standby area until being activated.

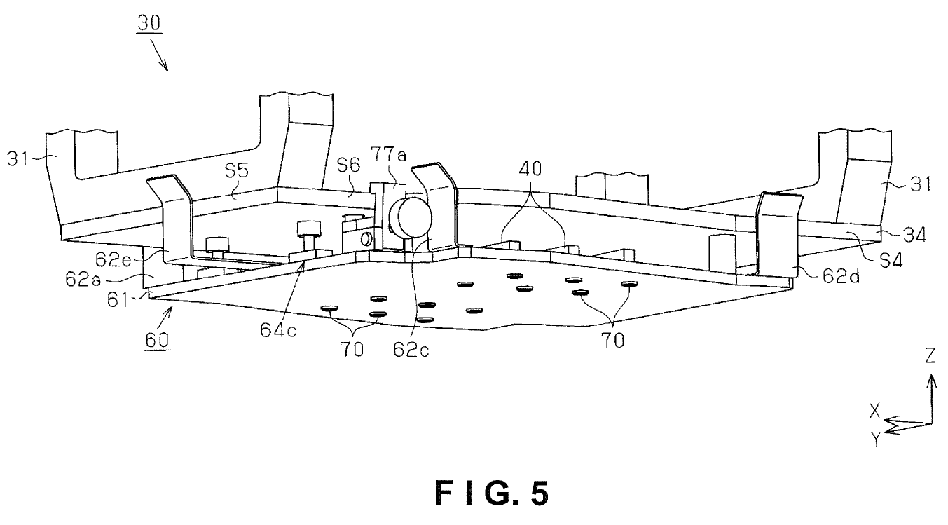

As shown in FIG. 5, a capping fixture 60 is attached to each of the carriages 30.

The capping fixture 60 has a base panel 61, and the base panel 61 is supported at a prescribed distance from the unit plate 34 to which the plurality of droplet discharge heads 40 fixed to the carriage 30 is attached.

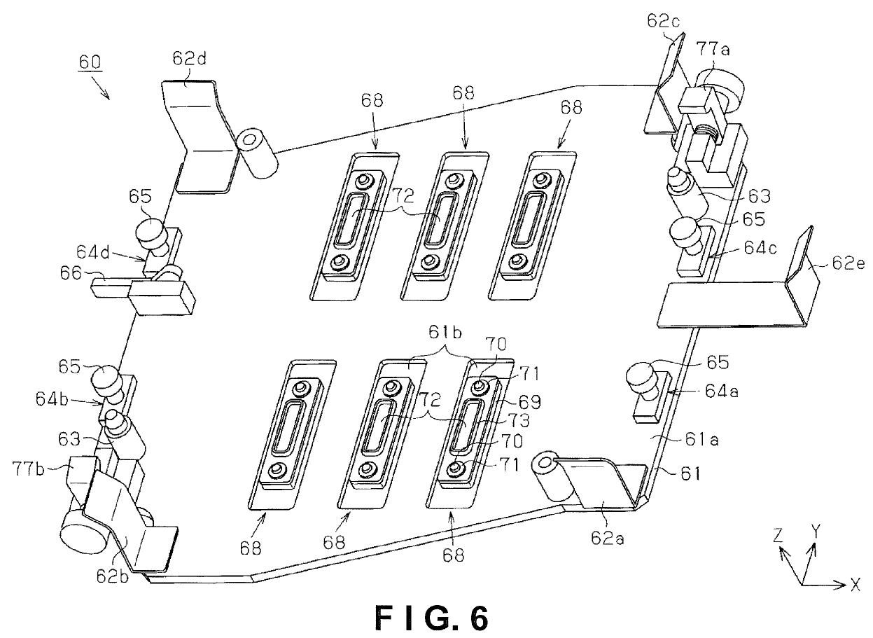

FIG. 6 is a perspective view showing the entire capping fixture 60 as viewed from above, and first through fourth positioning guide panels 62a, 62b, 62c, 62d as positioning members are fixed to the upper surface 61a of the base panel 61 at the four corners thereof. A fifth positioning guide panel 62e is fixed to the upper surface 61a of the base panel 61 in the center on one side thereof in the X-axis direction.

The first positioning guide panel 62a comes into contact with the first side surface S1 (see FIG. 3; same hereinafter) of the unit plate 34, the second positioning guide panel 62b comes into contact with the second side surface S2 of the unit plate 34, the third positioning guide panel 62c comes into contact with the third side surface S3 of the unit plate 34, the fourth positioning guide panel 62d comes into contact with the fourth surface S4 of the unit plate 34, and the fifth positioning guide panel 62e comes into contact with the fifth side surface S5 of the unit plate 34. The base panel 61 is thereby positioned with respect to the X-axis direction and Y-axis direction of the unit plate 34.

Positioning guide pins 63 as positioning members are fixed to the upper surface 61a of the base panel 61 on both ends thereof in the X-axis direction.

The positioning guide pins 63 are fitted in a pair of pin holes (not shown) provided to the unit plate 34. The base panel 61 is thereby precisely positioned with respect to the X-axis direction and Y-axis direction of the unit plate 34.

Pairs of height adjusting members 64a, 64b, 64c, 64d are also fixed to the upper surface 61a of the base panel 61 at both ends thereof in the X-axis direction. The height adjusting members 64a, 64b, 64c, 64d have adjustment screws 65 as contacting parts, and the heads of the adjustment screws 65 come into contact with the unit plate 34, whereby the base panel 61 is precisely positioned with respect to the Z-axis direction of the unit plate 34.

The heads of the adjustment screws 65 are composed of magnets, and when the base panel 61 is retained by the unit plate 34 while the position thereof is adjusted, the heads of the adjustment screws 65 are retained in close contact with the unit plate 34 by magnetic attraction.

A release lever 66 for removing from the unit plate 34 the base panel 61 retained in close contact with the unit plate 34 by the magnetic attraction of the heads of the adjustment screws 65 is provided to the other side in the X-axis direction of the upper surface 61a of the base panel 61.

Furthermore, first and second clamp devices 77a, 77b as connecting retention parts are fixed to both ends of the upper surface 61a of the base panel 61 in the X-axis direction.

The first clamp device 77a is connected so as to clamp the sixth side surface S6 (see FIG. 3; same hereinafter) of the unit plate 34, and the second clamp device 77b is connected so as to clamp the seventh side surface S7 of the unit plate 34, so that the base panel 61 does not separate from the unit plate 34 (see FIG. 5; the second clamp device 77b is not shown).

Consequently, when the base panel 61 is mounted to the lower side of the unit plate 34, the base panel 61 is guided by the first through fifth positioning guide panels 62a through 62e and the positioning guide pins 63, and the X-axis direction and Y-axis direction thereof are positioned, and the base panel 61 is positioned by the height adjusting members 64a through 64d with respect to the Z-axis direction, and connected to and retained on the unit plate 34 by the magnetic attraction of the adjustment screws 65. The base panel 61 is securely connected to and retained on the unit plate 34 by the first and second clamp devices 77a, 77b.

In the base panel 61 as shown in FIG. 6, head caps 68 (head cap portions) whose number (six in the present embodiment) corresponds to the droplet discharge heads 40 provided to the unit plate 34 are positioned so as to correspond to the droplet discharge heads 40.

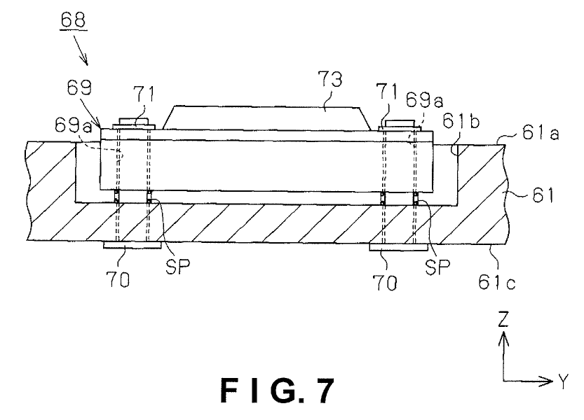

In each head cap 68, a cap body 69 is placed in a concave part 61b formed on the upper surface 61a in the base panel 61, as shown in FIG. 7. Through holes 69a are formed at both sides in the Y-axis direction of the cap body 69, and guide shafts 70 inserted from the lower surface 61c of the base panel 61 are passed through the through holes 69a. Retainer members 71 are attached to the distal ends of the guide shafts 70, and the cap body 69 can move along the guide shafts 70 without coming off the guide shafts 70.

Coil springs SP as elastic members are provided to the guide shafts 70 between the cap body 69 and the base panel 61. The cap body 69 (head cap 68) is therefore clamped and retained in a position (position of engagement with the retainer members 71) at a distance from the base panel 61 by the coil springs SP. When the cap body 69 (head cap 68) is pressed against the elastic force of the coil springs SP, the cap body 69 (head cap 68) moves toward the base panel 61.

A ring-shaped seal member 73 that is brought into close contact with the nozzle formation face 45a so as to enclose all of the discharge nozzles 46 of the droplet discharge head 40 is provided to the cap body 69 to hermetically seal the droplet discharge head 40. A cap chamber 72 that is open at the top is formed by the cap body 69 and the seal member 73.

Consequently, when the base panel 61 is connected to and retained on the unit plate 34, the head caps 68 provided to the base panel 61 are brought into close contact with the nozzle formation face 45a in a state in which the ring-shaped seal members 73 enclose all of the discharge nozzles 46 in the corresponding droplet discharge heads 40 provided to the unit plate 34. As a result, defects such as blockage due to exposure to outside air and drying of the functional liquid F are eliminated in the droplet discharge heads 40 provided to the unit plate 34.

At this time, even when attachment error in the Z-axis direction occurs for each of the droplet discharge heads 40 provided to the unit plate 34, the head caps 68 are clamped and retained by the guide shafts 70 and the coil springs SP so as to be able to move in the Z-axis direction, and are therefore reliably brought into close contact with the corresponding droplet discharge heads 40.

Such effects as the following can be obtained through the embodiment described above.

(1) According to the embodiment described above, the head caps 68 of the capping fixture 60 can move along the guide shafts 70, and are elastically retained in the direction of separation from the base panel 61 by the coil springs SP. Consequently, even when there are height deviations from the unit plate 34 of the droplet discharge heads 40 attached to the carriages 30, the seal member 73 can be reliably brought into close contact with the nozzle formation face 45a by the elastic force of the coil springs SP. Specifically, the droplet discharge heads 40 of the carriage 30 can be reliably sealed. As a result, drying of the functional liquid F in the droplet discharge heads 40 can be suppressed.

(2) According to the embodiment described above, the first through fifth positioning guide panels 62a through 62e and the positioning guide pins 63 are provided for adjusting the position of the capping fixture 60 with respect to the unit plate 34 when the capping fixture 60 is attached to the carriage 30. Consequently, the position of the capping fixture 60 (head caps 68) with respect to the unit plate 34 (droplet discharge heads 40) can be adjusted, and the head caps 68 can be reliably brought into close contact with the droplet discharge heads 40. As a result, the droplet discharge heads 40 can be reliably sealed.

(3) According to the embodiment described above, the height adjusting members 64a through 64d for adjusting the space between the unit plate 34 and the base panel 61 are provided to the base panel 61 of the capping fixture 60. The heads of the adjustment screws 65 of the height adjusting members 64a through 64d are also composed of magnets. Consequently, the sealing force of the head caps 68 with respect to the droplet discharge heads 40 can be increased by using the height adjusting members 64a through 64d to adjust the space between the unit plate 34 and the base panel 61. As a result, the droplet discharge heads 40 can be more reliably sealed.

The heads (magnets) of the adjustment screws 65 of the height adjusting members 64a through 64d are also brought into contact with the unit plate 34, whereby the capping fixture 60 can easily be retained in close contact with the unit plate 34. By operating the first and second clamp devices 77a, 77b from this state, the capping fixture 60 can easily be attached to the carriage 30.

(4) According to the embodiment described above, a release lever 66 is provided for separating the heads (magnets) of the adjustment screws 65 of the height adjusting members 64a through 64d from the unit plate 34 when the capping fixture 60 is retained in close contact with the unit plate 34 by the heads (magnets) of the adjustment screws 65 of the height adjusting members 64a through 64d.

Consequently, when the heads (magnets) of the adjustment screws 65 of the height adjusting members 64a through 64d are in contact with the unit plate 34, the capping fixture 60 can easily be removed from the unit plate 34 by operating the release lever 66.

(5) According to the embodiment described above, first and second clamp devices 77a, 77b are provided for connecting and fixing the capping fixture 60 to the carriage 30. Consequently, the capping fixture 60 can easily be manually connected and fixed to the carriage 30. As a result, since the droplet discharge heads 40 can be sealed, and drying of the functional liquid F can be suppressed without providing a large-sized capping device having, for example, a raising and lowering means, the cost of the droplet discharge device 1 can be reduced.

### Second Embodiment

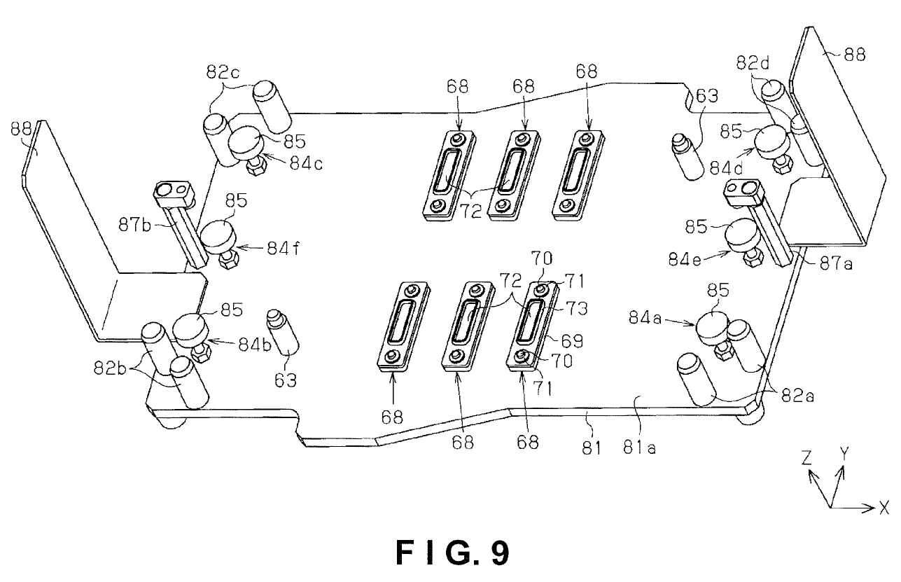

A second embodiment of the present invention will next be described according to FIGS. 8 and 9.

As shown in FIG. 8, the capping fixture 80 of the present embodiment is a capping fixture for preventing drying of the droplet discharge heads 40, and is attached to the carriage 30 when the carriage 30 removed from the carriage plate 21 (suspension support frame 28) is transported. The same reference symbols are used to refer to elements that are the same as in the first embodiment, and no description thereof will be given.

As shown in FIG. 9, the capping fixture 80 has a base panel 81, and the base panel 81 is fixed to the carriage 30 and retained at a prescribed distance with respect to the unit plate 34 to which the plurality of droplet discharge heads 40 is attached. The external shape of the base panel 81 is similar to that of the unit plate 34, albeit slightly larger.

First through fourth positioning guides 82a, 82b, 82c, 82d as positioning members in two groups are fixed to the four corners of the upper surface 81a of the base panel 81.

The first through fourth positioning guides 82a, 82b, 82c, 82d hold the four corners of the unit plate 34, whereby the base panel 81 is positioned with respect to the X-axis direction and Y-axis direction of the unit plate 34.

Furthermore, height adjusting members 84a, 84b, 84c, 84d, 84e, 84f are fixed to both ends of the upper surface 81a of the base panel 81 in the X-axis direction. The height adjusting members 84a through 84f have adjustment screws 85 as contacting parts, and the heads of the adjustment screws 85 come into contact with the unit plate 34, whereby the base panel 81 is precisely positioned with respect to the Z-axis direction of the unit plate 34.

The heads of the adjustment screws 85 are composed of magnets, and when the base panel 81 is retained by the unit plate 34 while the position thereof is adjusted, the heads of the adjustment screws 85 are retained in close contact with the unit plate 34 by magnetic attraction.

Furthermore, first and second clamp devices 87a, 87b as connecting retention parts are fixed to both ends of the upper surface 81a of the base panel 81 in the X-axis direction. The first and second clamp devices 87a, 87b are connected so as to clamp the lower edges 32 of the sides of a carriage frame 31 in the X-axis direction as shown in FIG. 8, and so that the base panel 81 does not separate from the carriage 30 (unit plate 34).

Consequently, when the base panel 81 is mounted to the lower side of the unit plate 34, the X-axis direction and Y-axis direction thereof are positioned by the first through fourth positioning guides 82a, 82b, 82c, 82d, and the base panel 81 is positioned by the height adjusting members 84a through 84f with respect to the Z-axis direction, and is connected to and retained on the unit plate 34 by the magnetic attraction of the adjustment screws 85. The base panel 81 is securely connected to and retained on the unit plate 34 by the first and second clamp devices 87a, 87b.

As shown in FIG. 9, the base panel 81 is also provided with head caps 68 having the same structure as in the first embodiment.

Consequently, when the base panel 81 is connected to and retained on the unit plate 34, the head caps 68 provided to the base panel 81 are brought into close contact with the nozzle formation face 45a in a state in which the ring-shaped seal members 73 enclose all of the discharge nozzles 46 in the corresponding droplet discharge heads 40 provided to the unit plate 34. As a result, defects such as blockage due to exposure to outside air and drying of the functional liquid F are eliminated in the droplet discharge heads 40 provided to the unit plate 34.

At this time, even when attachment error in the Z-axis direction occurs for each of the droplet discharge heads 40 provided to the unit plate 34, the head caps 68 are clamped and retained by the guide shafts 70 and the coil springs SP so as to be able to move in the Z-axis direction, and are therefore reliably brought into close contact with the corresponding droplet discharge heads 40.

Furthermore, tube fixing panels 88 as holding members that are folded in an L-shape are fixed to both ends of the upper surface 81a of the base panel 81 in the X-axis direction. As shown in FIG. 8, the tube fixing panels 88 fix together the duct connecting member 50 (see FIG. 2) for feeding the functional liquid F to the droplet discharge heads 40 from the functional-liquid feeding units 22 when the capping fixture 80 is connected to and retained on the carriage 30.

According to the embodiment described above, such effects as those described below can be obtained in addition to the effects described in (1) through (5) of the first embodiment.

(6) According to the embodiment described above, the tube fixing panels 88 for fixing together the duct connecting member 50 are provided to the capping fixture 80, whereby the duct connecting member 50 can be fixed when the carriage 30 is transported. Consequently, the carriage 30 can easily be transported.

The embodiments described above may be modified as described below.

In the first and second embodiments described above, the capping fixtures 60, 80 are connected to and retained on the carriage 30 through the use of the first and second clamp devices 77a, 77b and the first and second clamp devices 87a, 87b. This configuration is not limiting, and the capping fixtures 60, 80 may be connected to and retained on the carriage 30 using screws or the like.

In the first and second embodiments described above, the elastic members are coil springs SP. This configuration is not limiting, and leaf springs or the like, for example, may also be used.

In the first and second embodiments described above, a carriage 30 is described that has six droplet discharge heads 40 mounted therein. This configuration is not limiting, and the arrangement and number of droplet discharge heads mounted in the carriage may be appropriately changed.

In the first and second embodiments described above, a droplet discharge device is described for discharging droplets of a filter ink and forming a color filter on a CF substrate. This configuration is not limiting, and the present invention may be applied to a droplet discharge device for forming metal wiring, a droplet discharge device for forming an insulation layer, a droplet discharge device for forming a liquid crystal layer or an alignment film, a droplet discharge device for forming a luminescent layer of an organic EL display device, or the like.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A capping fixture adapted to be coupled to a droplet discharge device including a droplet discharge head aligned on a unit plate of a carriage, the capping fixture comprising:
a base panel;
a head cap portion disposed on the base panel at a position corresponding to the droplet discharge head to hermetically seal the droplet discharge head when the capping fixture is coupled to the carriage of the droplet discharge device; and
an elastic member elastically coupling the head cap portion with the base panel so that the head cap portion is movable within a prescribed distance in a direction substantially perpendicular to the base panel.

2. The capping fixture according to claim 1, further comprising
a connecting retention part configured and arranged to connect and retain the base panel to the carriage when the capping fixture is coupled to the carriage.

3. The capping fixture according to claim 1, further comprising
a positioning member configured and arranged to position the head cap portion with respect to the droplet discharge head when the capping fixture is coupled to the carriage.

4. The capping fixture according to claim 1, further comprising
a height adjusting member configured and arranged to adjust a gap between the unit plate of the carriage and the base panel when the capping fixture is coupled to the carriage, the height adjusting member having a contacting part that contacts the unit plate when the capping fixture is coupled to the carriage.

5. The capping fixture according to claim 4, wherein
the contacting part includes a magnet.

6. The capping fixture according to claim 5, further comprising
a release lever configured and arranged to release the contacting part from the unit plate when the capping fixture is separated from the carriage.

7. The capping fixture according to claim 1, further comprising
a holding member configured and arranged to hold a duct connection member connected to the carriage when the capping fixture is coupled to the carriage.

8. The capping fixture according to claim 2, further comprising
a positioning member configured and arranged to position the head cap portion with respect to the droplet discharge head when the capping fixture is coupled to the carriage.

9. The capping fixture according to claim 8, further comprising
a height adjusting member configured and arranged to adjust a gap between the unit plate of the carriage and the base panel when the capping fixture is coupled to the carriage, the height adjusting member having a contacting part that contacts the unit plate when the capping fixture is coupled to the carriage.

10. The capping fixture according to claim 9, wherein
the contacting part includes a magnet.

11. The capping fixture according to claim 10, further comprising
a release lever configured and arranged to release the contacting part from the unit plate when the capping fixture is separated from the carriage.
